(19) United States
(12) Patent Application Publication
(10) Pub. No.: US 2023/0128967 A1
(43) Pub. Date: Apr. 27, 2023

(54) SYSTEM, METHOD, AND COMPUTER PROGRAM PRODUCT FOR ADDITIVE MANUFACTURING OF BIOMIMETIC COMPONENTS FROM A BUILDING MATERIAL ON A MOVING BUILD PLATFORM

(71) Applicant: The Research Foundation for the State University of New York, Amherst, NY (US)

(72) Inventors: Ruogang Zhao, Amherst, NY (US); Chi Zhou, Getzville, NY (US)

(21) Appl. No.: 17/970,052

(22) Filed: Oct. 20, 2022

Related U.S. Application Data
(60) Provisional application No. 63/270,306, filed on Oct. 21, 2021.

(51) Int. Cl. B29C 64/124; B29C 64/255; B29C 64/264; B29C 64/245; B29C 64/232; B29C 64/393; B33Y 10/00; B33Y 30/00; B33Y 50/02; B33Y 70/00

(52) U.S. Cl. CPC B29C 64/124; B29C 64/255; B29C 64/264; B29C 64/245; B29C 64/232; B29C 64/393; B33Y 10/00; B33Y 30/00; B33Y 50/02; B33Y 70/00

(57) ABSTRACT

A system, method, and computer program product that allows the additive manufacturing of a component from a build material held within a tank, such as the manufacture of a hydrogel biomemetic structure. The tank includes a window with a light source positioned adjacent the window. A build platform is within the tank and opposite the light source and an actuator is coupled to the build platform that movie the build platform within the tank and relative to the window. A computing device is operably coupled to the actuator and controls the operation of the actuator to build a component by positioning the build platform within the tank at predetermined distances from the window with the build platform at least partially submerged in any build material contained in the tank, and moving the build platform relative to the window and the light source thereby building a component.

### CROSS-REFERENCE TO RELATED APPLICATION

This application claims the benefit of U.S. Provisional Application No. 63/270,306, filed Oct. 21, 2021, the entirety of which is hereby incorporated herein by this reference.

### STATEMENT REGARDING FEDERALLY SPONSORED RESEARCH

This invention was made with government support under Grant No. EB019411 awarded by the National Institutes of Health (NIH). The government has certain rights in the invention.

### BACKGROUND OF THE INVENTION

### 1. Field of the Invention

The disclosure relates generally to additive manufacturing. More particularly, present invention relates to systems and methods for building a component, such as a biomimetic structure, from a build material, such as hydrogel, by continuously moving a build platform within a tank containing the build material.

### 2. Description of the Related Art

Large scale cell-laden hydrogel models hold great promise for tissue repair and organ transplantation, but their fabrication is faced with challenges in achieving clinically-relevant size and hierarchical structures. 3D bioprinting is an emerging technology for hydrogel fabrication and has been successfully used to create hydrogel models with biomimetic structures and functions. However, its application in large, solid hydrogel fabrication has been limited by the slow printing speed that can affect the part quality and the biological activity of the encapsulated cells.

Due to the point-by-point deposition process used in nozzle-based bioprinting techniques, extended printing time is required to fabricate a large-sized model with fine structures. Prolonged exposure of the encapsulated cells to a variety of printing-induced environmental factors, such as the shear stress, the low oxygen level and the temperature shock, has been shown to cause serious cellular injury and cell death. The effort to improve the printing resolution by using small diameter nozzles can cause further damage to the cells. Additionally, due to the low mechanical strength of the hydrogel scaffold materials, it is very challenging for point-by-point deposition methods to create overhanging or hollow structures such as vascular channels inside solid parts

To address this limitation, the prior art has utilized rigid polymeric scaffolds to support the printing of cell-laden hydrogel materials, as well as extruded hydrogel material in a secondary supporting hydrogel to print biomimetic structures such as a heart chamber. However, these approaches suffer from either the high rigidity of the supporting material or the complexity of the post-processing steps. Although extrusion printing of dissolvable templates composed of sacrificial materials such as fugitive inks and carbohydrate glass has enabled the creation of perfusable vascular channels in casted hydrogel constructs, this approach has very limited capacity to create fine tissue structures other than vascular channels due to the simple casting method used.

Digital mask projection-stereolithography (MP-SLA) is a photopolymerization-based, layer-by-layer 3D printing technology that features multi-scale fabrication capacity with high spatial resolution, allowing the bulk geometry and fine structure of a complex 3D model to be built through one single process. In MP-SLA, the liquid resin provides natural self-support for the fabrication of hollow structures. This approach has been used to fabricate hydrogel models such as nerve conduits and muscle-powered biobots. Recently, multivesicular networks have been created in hydrogels by controlling the spatial resolution of hydrogel photopolymerization using selected food dye photo absorbers. However, the layer-by-layer process used in these studies limited the printing speed, which can potentially cause dehydration-induced part deformation and reduced cell viability during the fabrication of large-sized hydrogel parts.

Another extant method to bioprint components has been the development of continuous liquid interface production (CLIP) to drastically increased the fabrication speed of MP-SLA through continuously building the layers of a 3D part immediately above a “dead zone” formed by oxygen inhibition of photopolymerization. In the dead zone, the flow of liquid water-insoluble-resin (WI-resin) enables continuous material replenishment at the polymerization interface. However, due to the low fluidity of the WI-resin material and the corresponding large suction force at the curing interface, the fabrication ability of the CLIP technology is limited to thin-walled parts. The fabrication of a centimeter-sized solid hydrogel part has not yet been achieved using CLIP.

### BRIEF DESCRIPTION OF THE INVENTION

A first aspect of the disclosure provides an additive manufacturing system, including a tank containing a build material, the tank including a window. A light source is positioned externally adjacent to the tank and providing light through the window of the tank. A build platform positioned within the tank and opposite the light source and window, the build platform preferably vertically aligned with the window. An actuator device is coupled to the build platform and moves the build platform relative to the window. At least one computing device is operably coupled to the actuator device, the at least one computing device configured to control the operation of the actuator device when building a component from the build material on the build platform by initially positioning the build platform within the tank at predetermined distance from the window with the build platform at least partially submerged in any build material contained in the tank, and continuously moving the build platform relative to the window while building the component from the build material from the photochemical action of light from the light source.

A second aspect of the disclosure provides a method for building a component from a build material. The method includes positioning a build platform within a tank at a predetermined distance from a window of the tank, the build platform at least partially submerged in any build material contained in the tank, exposing at least a portion of the build material positioned between the build platform and the window of the tank to a light to photochemically alter a composition of the build material, and moving the build platform relative to the window of the tank during the exposure to additively create the component.

A third aspect of the disclosure provides a computer program product including program code stored on a non-transitory computer readable storage medium, which when executed by at least one computing device, causes the at least one computing device to build a component from a build material using an additive manufacturing system by performing a processes including the steps of positioning a build platform of the additive manufacturing system within a tank of the additive manufacturing system at predetermined distance from a window of the tank, the build platform at least partially submerged in any build material contained in the tank, exposing at least a portion the build material positioned between the build platform and the window of the tank to a light generated by a light source of the additive manufacturing system to photochemically alter a composition of the build material, and moving the build platform relative to the window of the tank during the exposure to thereby additively manufacture the component.

The present invention is therefore advantageous as it allows the production of large-scale cell-laden hydrogel biomimetic models which can be used for tissue repair and organ transplantation. The present invention thus has industrial applicability as it permits the bioprinting of biomimetic structures at a manufacturing scale. It is thus to these, as well as other advantages that would be apparent to one of skill in the art, that the present invention is directed.

### BRIEF DESCRIPTION OF THE DRAWINGS

FIG. 1 shows a perspective view of an additive manufacturing system, according to embodiments of the disclosure.

FIG. 2 shows a front cross-sectional view of a portion of the additive manufacturing system of FIG. 1 taken along line CS-CS, according to embodiments of the disclosure.

FIG. 3 shows a front cross-sectional view of the portion of the additive manufacturing system of FIG. 1 taken along line CS-CS including a partially-built component, according to embodiments of the disclosure.

FIG. 4 shows an enlarged, front cross-sectional view of a partially-built component of FIG. 3 and a build material used in the additive manufacturing system of FIG. 1, according to embodiments of the disclosure.

FIG. 5 shows a front cross-sectional view of the portion of the additive manufacturing system of FIG. 1 taken along line CS-CS including a built component, according to embodiments of the disclosure.

FIG. 6 shows front cross-sectional views of the portion of the additive manufacturing system of FIG. 1 taken along line CS-CS including a built component, according to additional embodiments of the disclosure.

FIG. 7 shows front cross-sectional views of the portion of the additive manufacturing system of FIGS. 1 and 6, according to additional embodiments of the disclosure

FIG. 8 shows front cross-sectional views of the portion of the additive manufacturing system of FIG. 1 taken along line CS-CS including a built component, according to additional embodiments of the disclosure

FIG. 9 shows a front cross-sectional view of a portion of the additive manufacturing system of FIG. 1 taken along line CS-CS, according to further embodiments of the disclosure.

FIG. 10 shows a flowchart illustrating processes for building a component from a build material using an additive manufacturing system, according to embodiments of the disclosure.

FIG. 11 shows a schematic view of a computing system configured to building a component from a build material using an additive manufacturing system, according to embodiments of the disclosure.

### DETAILED DESCRIPTION OF THE INVENTION

As an initial matter, in order to clearly describe the current disclosure it will become necessary to select certain terminology when referring to and describing relevant components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

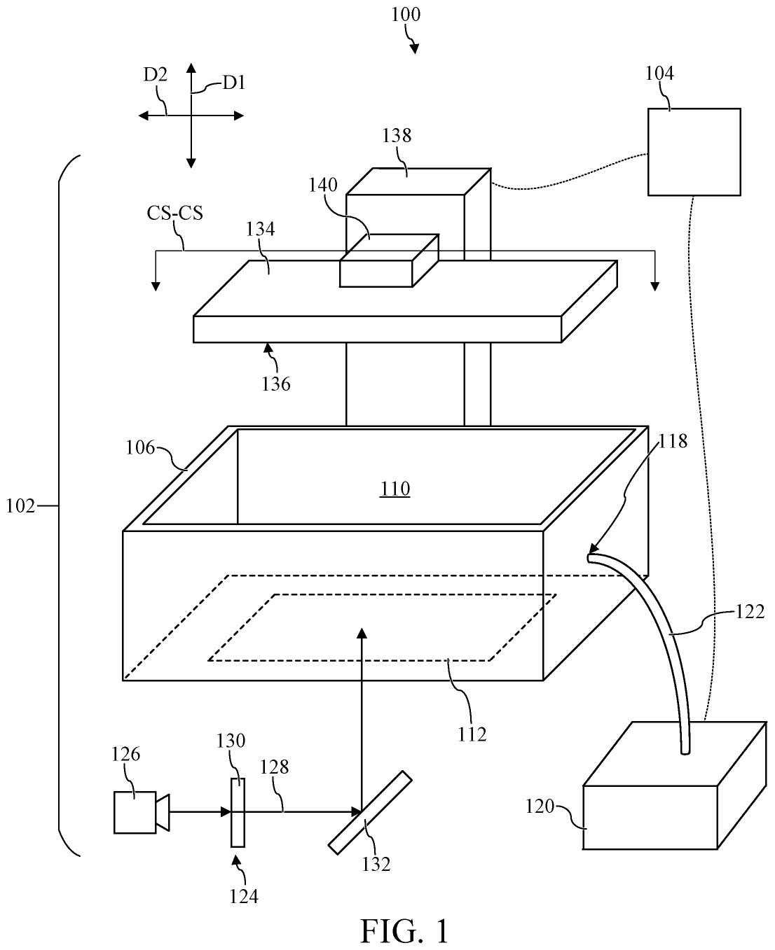

As discussed herein, the disclosure relates generally to additive manufacturing, and more particularly, to systems and methods for building a component from a hydrogel build material by continuously moving a build platform. These and other embodiments are discussed below with reference to FIGS. 1-11. However, those skilled in the art will readily appreciate that the detailed description given herein with respect to these Figures is for explanatory purposes only and should not be construed as limiting.

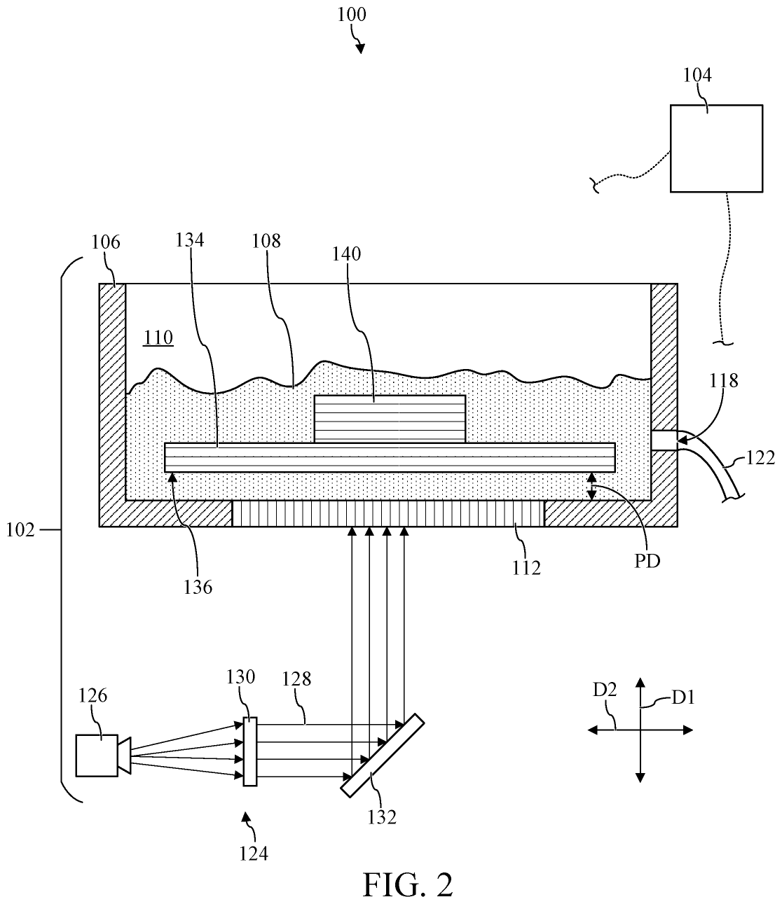

FIGS. 1 and 2 show various views of additive manufacturing system 100 (hereafter, “AM system 100”). More specifically, FIG. 1 shows a perspective view of additive manufacturing system 100, and FIG. 2 shows a front cross-sectional view of additive manufacturing system 100 taken along line CS-CS. In the non-limiting example, additive manufacturing system 100 may include an additive manufacturing apparatus 102 (hereafter, “AM apparatus 102”) and at least one computing device 104 operably coupled and/or in electronic communication with at least one device of AM apparatus 102. As discussed herein, additive manufacturing system 100 may build, form, and/or create a component or part using a build material by continuously moving a build platform of the AM apparatus 102 during the build process.

In the non-limiting example, AM apparatus 102 may include a build tank 106 (hereafter, “tank 106”). Tank 106 may contain a build material 108 (see, FIG. 2). More specifically, tank 106 may hold, contain, and/or receive build material 108 within a cavity 110 defined by tank 106. Tank 106 may be formed as any suitable container, receptacle, and/or vessel that may contain/receive build material 108 during the build process and/or may be formed from any suitable material that may contain and maintain the build material 108. Build material 108 may be utilized by AM apparatus 102 for forming the component or part, as discussed herein. In a non-limiting example, build material 108 included within AM apparatus 102 may be (liquid) prepolymer hydrogel material. Hydrogel material forming build material 108 may include, but is not limited to, Poly(ethylene glycol) diacrylate (PEGDA), gelatin methacrylate (GeIMA), a combination of PEGDA and GeIMA, methacrylated hyaluronic acid (MeHA), or any other suitable photo-crosslinkable hydrogel. Additionally, the hydrogel material forming build material 108 may include predetermined material characteristics. For example, the hydrogel forming build material 108 may include a predetermined viscosity, flow rate, predetermined stiffness of partially-cured/completely-cured hydrogel forming the component, and/or concentration (e.g., build material/water ratio) of hydrogel. As discussed herein, the predetermined viscosity may aid build material 108 (e.g., hydrogel) to continuously flow or move within tank 106 during the build process, and the predetermined light transmittance and photo absorbance properties may determine the success of the continuous flow of the build material 108 in tank 106 as these characteristics at least partially determine the dynamic photochemical alteration of build material 108 during the build process.

In the non-limiting example shown in FIGS. 1 and 2, tank 106 may also include a window 112. More specifically, window 112 (shown in phantom in FIG. 1) may be formed within and/or integral with a bottom portion of tank 106. Window 112 may be substantially or completely transparent. Additionally, window 112 may be formed from any suitable material that may allow for a light to pass therethrough and photochemically alter a composition of build material 108 contained in tank 106 during the build process, as discussed herein. In a non-limiting example window 112 may be formed from glass. Additionally in non-limiting examples, the size or dimension of window 112 may be based on, at least in part, the size or dimension of a build platform of AM apparatus 102.

Tank 106 of AM apparatus 102 may also include at least one fluid inlet 118. In the non-limiting example shown in FIGS. 1 and 2, tank 106 may include a single fluid inlet 118 positioned on and/or through opposing sides of tank 106. Inlet(s) 118 may be in fluid communication with tank 106/cavity 110 of tank 106 containing build material 108. As discussed herein, inlet 118 may provide additional build material 108 to cavity 110/tank 106 during the build process forming a component using AM apparatus 102. In the non-limiting example, additional build material 108 may be provided from a reservoir 120 fluidly coupled and/or in fluid communication with inlet(s) 118 via a conduit 122. That is, during the build process as build material 108 is photochemically altered to form a component, additional build material 108 may need to be added to tank 106 to ensure the component may be completely built or formed. In the example shown, additional build material 108 may be provided to tank 106/cavity 110 by flowing build material 108 from reservoir 120 to tank 106 via conduit 122 and inlet(s) 118, respectively. Although a single inlet 118 is shown, it is understood that tank 106 of AM apparatus 102 may include more inlets.

Although shown as including inlet(s) 118, it is understood that tank 106 may not include inlet(s) 118. That is, and as discussed herein, tank 106 may be sized to include the required amount of build material 108 to form the entirety of the component using AM apparatus 102 without the need for additional build material 108 to be added. In this non-limiting example, AM apparatus 102 may not include inlet(s) 118, reservoir 120, and conduit 122, respectively.

AM apparatus 102 of additive manufacturing system 100 may also include a light system 124. Light system 124 of AM apparatus 102 may include a light source 126. Light source 126 may be positioned adjacent tank 106. In the non-limiting example, light source 126 may be positioned adjacent to and/or substantially below window 112 included in tank 106. Light source 126 may be formed as any suitable device, component, and/or apparatus that may generate a light 128 for forming the component using build material 108, as discussed herein. Light 128 generated by light source 126 may include various predetermined characteristics (e.g., light energy, light intensity, wavelength, uniformity, etc.) which may cause the composition of build material 108 to be photochemically altered (e.g., solidified) during the build process discussed herein.

Light system 124 of AM apparatus 102 may also include a photomask component 130. Photomask component 130 may be positioned downstream of light source 126 and/or may be positioned between light source 126 and window 112 of tank 106. Photomask component 130 may allow a pattern of light 128 generated by light source 126 to pass therethrough to a lens 132, that in turn redirects light 128 toward and through window 112. As discussed herein, light 128 that passes through photomask component 130 and ultimately window 112 of tank 106 may photochemically alter the composition of build material 108 to form a component. Because a build platform of AM apparatus 102 continuously moves during the build process, as discussed herein, photomask component 130 may be formed from a dynamic, variable photomask component that may dynamically alter the pattern that allows/blocks light 128 from reaching window 112 of tank 106. The pattern for variable photomask component 130 may define geometries of the component built from build material 108. In a non-limiting example, photomask component 130 may be formed as a dynamic digital mask generator, a digital micromirror device (DMD), liquid crystal display (LCD), liquid crystal on silicon (LCoS), or any other suitable masking device.

In the non-limiting example shown in FIGS. 1 and 2, AM system 100 may also include a build platform 134. Build platform 134 may be positioned adjacent tank 106 of AM apparatus 102. Additionally, build platform 134 may be positioned opposite light source 126, such that tank 106, and more specifically window 112, may be positioned between light source 126 and build platform 134. As shown in FIG. 2, build platform 134 may also be at least partially (vertically) aligned with window 112 of tank 106. Build platform 134 may also include a build surface 136 positioned directly adjacent window 112 of tank 106. As discussed herein, build surface 136 of build platform 134 may receive photochemically altered build material 108 and/or component formed from build material 108 using AM apparatus 102. Build platform 134 may be made from any suitable material capable of withstanding the processes for building a component using AM apparatus 102. In non-limiting examples, build platform 134 may be formed from stainless steel, aluminum, titanium, nickel, cobalt or iron alloys, or any other material having similar physical, material and/or chemical characteristics.

AM apparatus 102 of AM system 100 may further include an actuator device 138. Actuator device 138 may be positioned adjacent to tank 106. Additionally, and as shown in FIGS. 1 and 2, actuator device 138 may be coupled to build platform 134. More specifically, an arm 140 of actuator device 138 may be coupled and/or affixed to a portion of build platform 134 positioned opposite build surface 136. Actuator device 138 may be configured to move build platform 134 within AM apparatus 102. That is, and as discussed herein, actuator device 138 may move build platform 134 in a first direction (D1) toward and/or away from tank 106 during the build process for forming the component from build material 108. Additionally, actuator device 138 may also move build platform 134 in a second direction (D2) during the build process. Actuator device 138 may be formed from any suitable device or apparatus that may move, actuate, and/or reposition build platform 134 during the build process. For example, actuator device 138 may be formed as a pneumatic actuator, hydraulic actuator, electric actuator, mechanical actuator, and the like.

As shown in FIGS. 1 and 2, AM system 100 may also include at least one computing device 104. Computing device 104 may be in operable communication with AM apparatus 102. More specifically, computing device 104 may be connected to, in communication with, and/or operably connected with actuator device 138 of AM apparatus 102. Additionally, computing device 104 may be connected to, in communication with, and/or operably connected with reservoir 120 and light source 126 of AM apparatus 102. As a result, and during operation, computing device(s) 104 may control each of the respective portions of AM apparatus 102 to perform processes for building a component from build material 108, as discussed herein. Computing device(s) 104 may be a stand-alone device, or alternatively may be a portion and/or included in a larger computing device (not shown) of AM system 100. For example, and as shown in FIG. 1, computing device(s) 104 may be separate from AM apparatus 102. Alternatively, computing device(s) 104 may be part of the overall computing system that is used in the operation of AM apparatus 102. As such, computing device(s) 104 may be formed as any device and/or computing system/network that may be configured to perform the processes discussed herein to build a component from build material 108. As discussed herein, computing device 104 may be configured to control the various portions of AM apparatus 102 to perform the build process. As shown in FIG. 1, computing device(s) 104 may be in electronic communication with and/or communicatively coupled to various devices, apparatuses, and/or portions of AM apparatus 102. In non-limiting examples, computing device 104 may be hard-wired and/or wirelessly connected to and/or in communication with actuator device 138, and/or other components via any suitable electronic and/or mechanical communication component or technique. For example, computing device(s) 104 may be in electronic communication with actuator device 138.

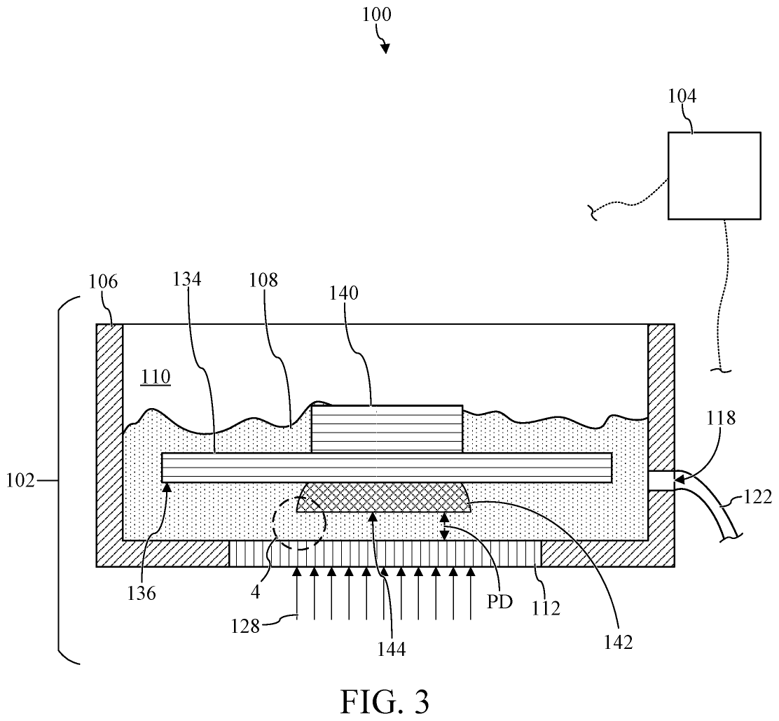

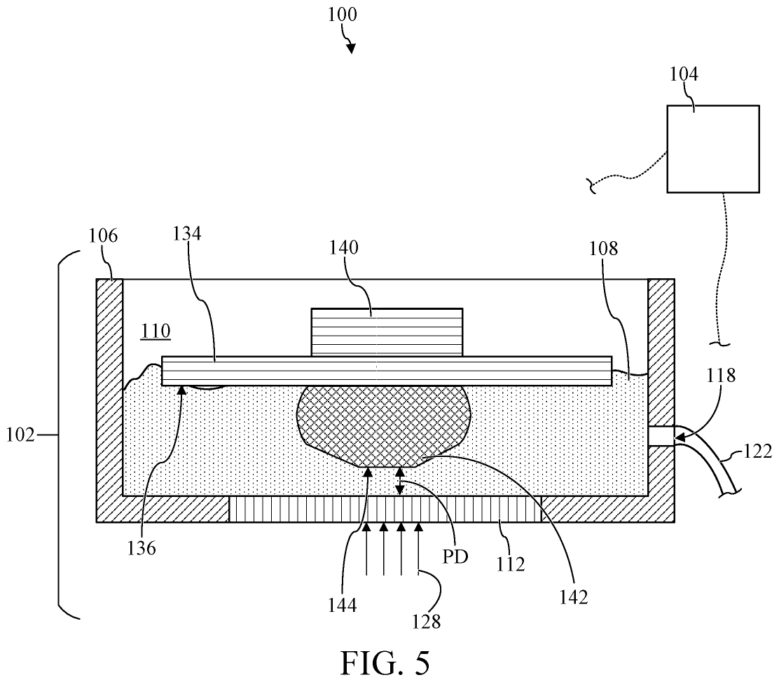

Turning to FIGS. 3-5, with continued reference to FIGS. 1 and 2, processes for forming and/or building a component 142 (see, FIG. 5) from build material 108 are shown. In the figures light system 124 is omitted for clarity. It is understood that similarly numbered and/or named components may function in a substantially similar fashion. Redundant explanation of these components has been omitted for clarity.

During the build process, build platform 134 may be initially positioned within tank 106. More specifically, and as shown in FIG. 2, at the start of the build process build platform 134 may be positioned within tank 106/cavity 110 at a predetermined distance (PD) from window 112 of tank 106. Additionally as shown, build platform 134 may be positioned within tank 106 such that build platform 134/build surface 136 is submerged in build material 108 contained within cavity 110 of tank 106. The position of build platform 134 within AM system 100, and more specifically tank 106 of AM apparatus 102, may be controlled, adjusted, and/or determined by computing device(s) 104. That is, computing device(s) 104 may communicate with actuation device 138 to control the movement and/or positioning of build platform 134/build surface 136 during the build process.

Once build platform 134 is positioned within the tank 106 and/or submerged in build material 108, at least a portion of build material 108 may be exposed to light 128. More specifically, at least a portion of build material 108 positioned between build platform 134/build surface 136 and window 112 of tank 106 may be exposed to light 128 generated by light source 126 of light system 124. Exposure to light 128 may photochemically alter the composition of the exposed portion of build material 108. That is, exposure to light 128 may cause the liquid build material 108 to be solidified (e.g., monomers/oligomers of prepolymer hydrogel material to cross-link together and form solidified polymers), to form component 142 (see, FIG. 5) using AM system 100. The portions of build material 108 that may be exposed to light 128 may be determined, controlled, and/or defined by photomask component 130 of light system 124. Initially, portions of exposed build material 108 may be solidified directly on build surface 136 of build platform 134, such that the formed component 142 may be coupled, attached, and/or affixed to build platform 134.

During the build process, build material 108 may be continuously exposed to light 128. More specifically, once light 128 from light source 126 is projected into tank 106 via window 112, and component 142 is being formed therein, build material 108 may be continuously exposed to light 128. The continuously exposure to light may continuously photochemically alter the composition of build material 108 to form solidified component 142. During this process, the predetermined light transmittance and photo absorbance properties of the build material 108 may affect the continuous photochemical alteration of build material 108 and the quality (spatial resolution, stiffness, coloration, etc) of built component 142. In addition to continuously exposing build material 108 to light 128, and continuously moving build platform 134 as discussed herein, the photomask component 130 of light system 124 may also be (continuously) altered during the build process. More specifically, during the continuously exposure of build material 108 to light 128, a pattern of light 128 that may be provided to and/or through window 112 of tank 106 may be continuously and/or dynamically altered using variable photomask component 130. The dynamically altered pattern of light 128, as determined by photomask component 130, may define a geometry, shape, and/or configuration of component 142 built from build material 108. Because build material 108 is continuously exposed to light 128 (e.g., not intermittently, in stages, and/or layer dependent), the pattern defined by photomask component 130 may also be continuously variable and/or dynamically changed. Computing device(s) 104 in communication with light system 124, and more specifically light source 126, may control the continuous exposure of build material 108 to light 128 during the build process. Additionally, computing device(s) 104 in communication with photomask component 130 of light system 124 may continuously adjust and/or dynamically alter the pattern defined by photomask component 130 during the continuous exposure process.

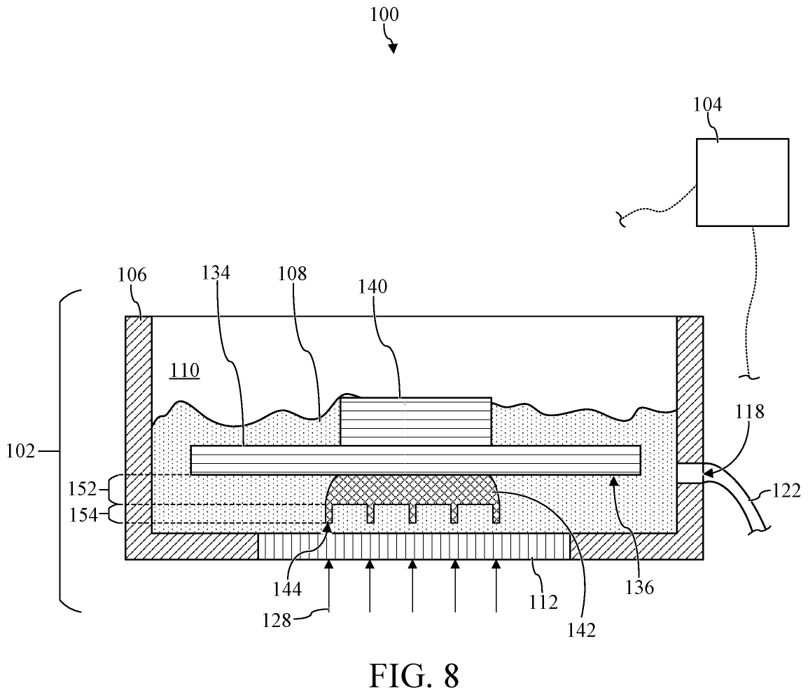

Because build material 108 is continuously exposed to light 128 to form component 142, build platform 134 must move also. That is, build platform 134 may be required to move as component 142 is continuously formed within tank 106 as a result of the continuous exposure to light 128 to prevent any portion of component 142 from being formed directly on and/or contacting window 112. Simultaneous to, or alternatively immediately after (e.g., less than 3 seconds), the continuous exposure to light 128, build platform 134 may continuously move from the initial position (e.g., the predetermined distance (PD) from window 112) and/or may move away from window 112 of tank 106. Build platform 134 and/or build surface 136 may move continuously, uninterruptedly, and/or perpetually during the continuous exposure/build process until component 142 is completely formed or built. In a non-limiting example, continuously moving build platform 134 may include uninterruptedly repositioning or moving build platform 134 away from window 112 of tank 106 at a single, predetermined speed. The single, predetermined speed may allow for component 142 to be build from build material 108 while both continuously exposing build material 108 to light 128 and continuously moving build platform 134 away from window 112. In the non-limiting example, the single, predetermined speed may be based upon, at least in part, the size/shape/geometry/features of component 142 being built, material characteristics of build material 108, predetermined characteristics (e.g., light energy, light intensity, wavelength, uniformity etc.) of light 128 generated by light source 126, and/or oxygen concentration in build material 108. In another non-limiting example, and as discussed herein (see, FIG. 8), continuously moving build platform 134 may include uninterruptedly repositioning build platform 134 away from window 112 of tank 106 at a plurality of predetermined speeds. Each of the plurality of predetermined speeds may be distinct form one another, and each of the plurality of predetermined speeds may be based or dependent on, at least in part, the geometry/size/shape/features of distinct sections of component 142, material characteristics of build material 108, predetermined characteristics (e.g., light energy, light intensity, etc.) of light 128 generated by light source 126, and/or oxygen concentration in build material 108.

As discussed herein, as component 142 is formed by continuously exposing build material 108 to light 128, actuator device 138 may continuously move build platform 134 away from window 112 of tank 106. As such, and as component 142 is continuously built, the distance between build surface 136 of build platform 134 and window 112 may also continuously increase from the predetermined distance (PD) (see, FIG. 2). However, the distance between the most recently built portion, section, and/or exposed surface 144 of (partially-built) component 142 formed from build material 108 may be positioned the predetermined distance (PD) from window 112. More specifically, and as shown in FIG. 3, build platform 134 may continuously move away from window 112 at a predetermined speed(s) such that an immediately built portion and/or exposed surface 144 of (partially-built) component 142 may be the predetermined distance (PD) from window 112 of tank 106. Briefly turning to FIG. 5, final or complete component 142 shown in the non-limiting example may be the predetermined distance (PD) from window 112 upon completion and/or before removal from tank 106 and/or build platform 134. As similarly discussed herein with respect to initially positioning build platform in tank 106, computing device(s) 104 may communicate with actuation device 138 to control the continuous movement and/or uninterrupted repositioning of build platform 134 during the build process.

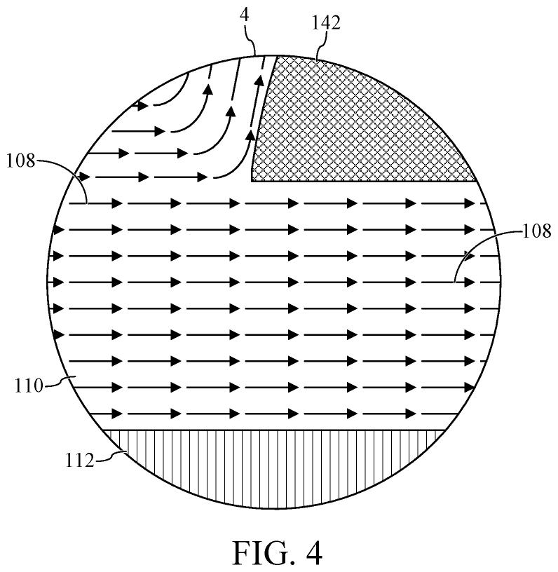

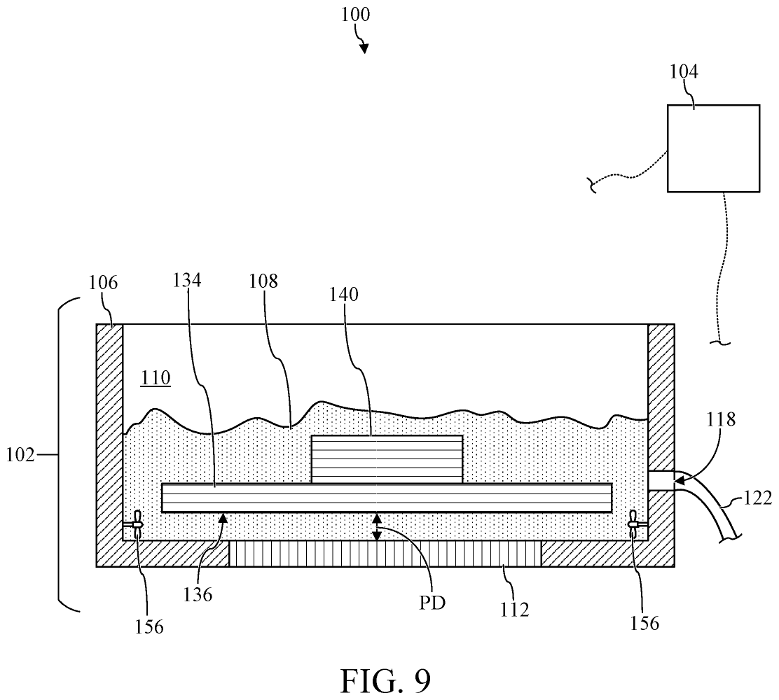

FIG. 4 shows an enlarged view of a portion of FIG. 3 including window 112 of tank 106, build material 108, and component 142. In the non-limiting example, the arrows may indicate and/or represent the flow path of build material 108 within tank 106 during the build process. More specifically, while component 142 is being formed via the continuous exposure to light 128 and continuous movement of build platform 134 away from window 112 build material may (continuously flow) between window 112 of tank 106 and build platform 134/component 142. In an example, build material 108 may flow between window 112 and build platform 134 as a result of material characteristics (e.g., viscosity, flow rate) of build material 108, as well as a suction force created within cavity 110 of tank 106. That is, and as a result of the continuous movement of build platform 134 away from window 112 during the build process, a suction force may be generated within tank 106 between continuously moving build platform 134 and build material 108 included in tank 106. The suction force generated by continuously moving build platform 134 may pull, draw, and/or trawl build material 108 in a direction toward the space between tank 106/window 112 and build platform 134/exposed surface 144 of component 142. Additionally, the build material 108 positioned above exposed surface 144 and/or adjacent build platform 134 may flow toward component 142 and subsequently create a wake-effect adjacent to and/or around component 142. The flow of the “waked” build material 108 may also aid in flowing or moving build material to the space between window 112 and build platform 134/exposed surface 144 of component 142. In other non-limiting examples (see, FIG. 9) additional devices/components may be used to ensure build material 108 continuously flows between window 112 and build platform 134/component 142. Continuously flowing build material 108 to the space between window 112 of tank 106 and build platform 134/component 142 may ensure component 142 may be built using continuous light 128 exposure from light source 126 and continuous movement of build platform 134.

In a non-limiting example where tank 106 includes fluid inlet(s) 118, the build process may also include providing additional build material 108 to cavity 110 of tank 106 during the continuous exposure. That is, as component 142 is continuously built using build material 108, additionally build material 108 may be provided to tank 106 to ensure AM apparatus 102 includes enough build material 108 to completely build component 142 in a single process (e.g., single continuous exposure, single continuous movement of build platform 134). As discussed herein, additional build material 108 may be added or provided to cavity 110 of tank 106 via reservoir 120 in fluid communication fluid inlet(s) 118 by conduit 122. Any suitable device or component may be used to provide additional build material 108 from reservoir 120 to tank 106 (e.g., pump). Computing device(s) 104 may be operably coupled to reservoir 120 and/or a device for flowing build material from reservoir 120 in order to provide additional build material 108 to tank 106 during the build process.

Returning to FIG. 5, once component 142 is complete, light source 126 may cease the generation of light 128, and build material 108 may no longer be exposed to light 128. Additionally, actuator device 138 may move or carry build platform 134 from tank 106, and/or build platform 134 may be subsequently uncoupled from actuator device 138. Once build platform 134 is removed from tank 106 and/or uncoupled from actuator device 138, component 142 may be removed, uncoupled, and/or separated from build surface 136. Component 142 may then undergo post-processing (e.g., polishing, coating, buffing, etc.) before being used for its intended purpose.

The continuous exposure to light 128, as well as the continuous movement of build platform 134, during the build process may decrease the build time for component 142 from conventional processes. Furthermore, the continuous exposure to light 128 and continuous movement of build platform 134 as discussed herein may also improve the quality of component 142 created using AM system 100. More specifically, because the build time is reduced, the risk of dehydration in the hydrogel material (e.g., build material 108) used to form component 142 may be substantially reduced or eliminated. This in turn may reduce or eliminate build defects in component 142 such as distortion, cracking, splitting, structural misalignments, and/or delamination. Furthermore, cell cultures included in the hydrogel material may also be substantially protected and/or remain unaffected when building component 142 using the continuous exposure/continuous movement process discussed herein.

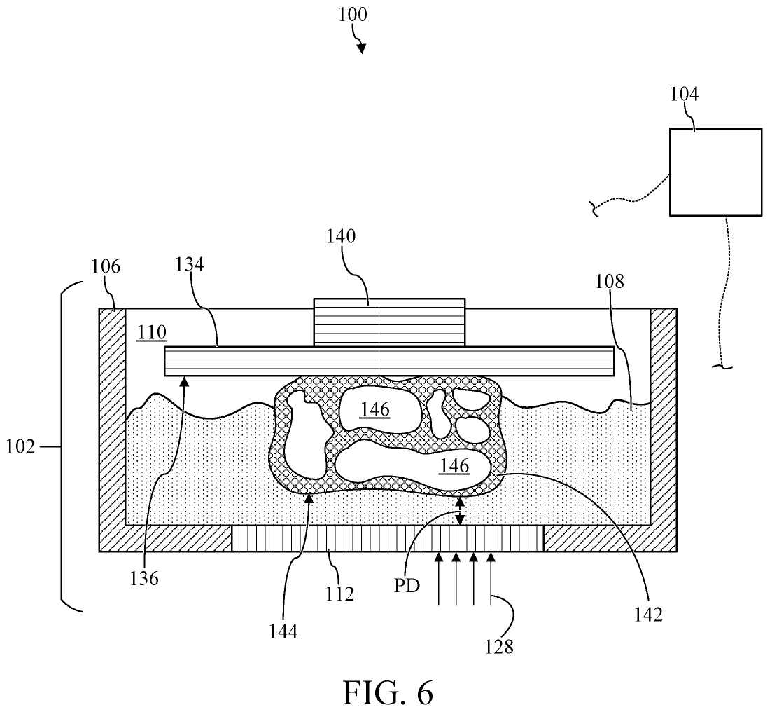

FIGS. 6-9 show additional cross-sectional views of AM system 100, according to non-limiting examples. It is understood that similarly numbered and/or named components may function in a substantially similar fashion. Redundant explanation of these components has been omitted for clarity.

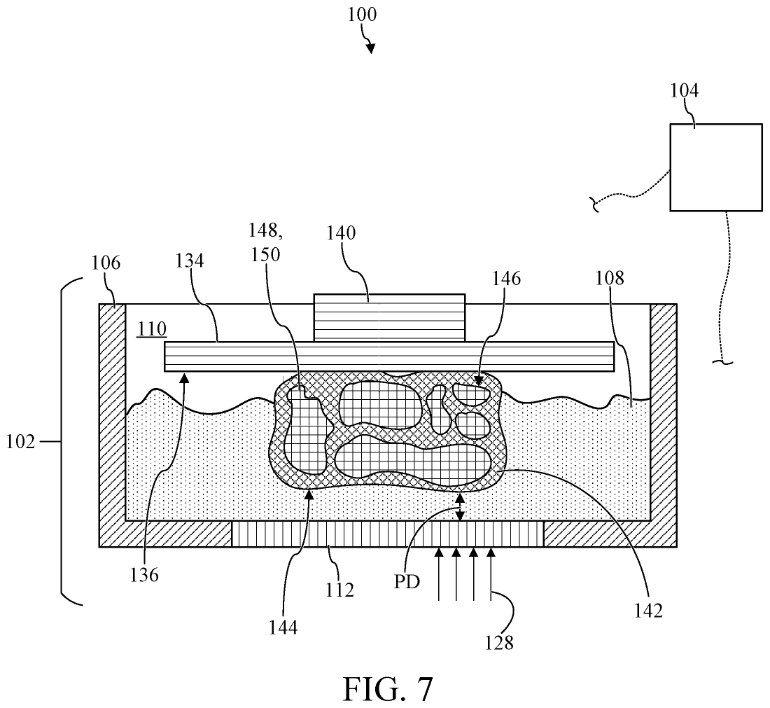

FIGS. 6 and 7 show component 142 may include internal features formed or included therein. For example, component 142 may include a plurality of channels 146 (e.g., vascular channels) extending therethrough. In the non-limiting example of FIG. 6, channels 146 may be formed in component 142 based on the pattern defined by photomask component 130. That is, channels 146 may be formed during the build process for forming component 142 as similarly discussed herein with respect to FIGS. 2-5. In the non-limiting example of FIG. 7, channels 146 may be formed by first forming a “negative” structure 148 from a distinct material 150. “Negative” structure 148 may be first formed on build platform 134 using AM system 100 as similarly discussed herein, or alternatively may be formed using other suitable methods/systems (e.g., casting). Once formed, “negative” structure 148 may be positioned on build platform 134, and component 142 may be formed around “negative” structure 148 using the similar continuous exposure/continuous movement build process discussed herein with respect to FIGS. 2-5. After component 142 is completely built, “negative” structure 148 may be removed from component 142 to form channels 146 therein. In a non-limiting example, “negative” structure 148 may be formed from distinct material 150 (e.g., sucrose) that may be dissolved or disintegrate when exposed or coming in contact with a solution (e.g., water).

FIG. 8 shows another non-limiting example of component 142 built using AM system 100. In the non-limiting example, component 142 may include two distinct portions 152, 154. As shown, each portion 152, 154 has distinct geometries, shapes, configurations, and/or sizes. More specifically, a first portion 152 includes a larger, more continuous unibody configuration, while second portion 154 of component 142 may be formed as five, smaller fingers or protrusions. The speed in which build platform 134 moves from window 112 during the build process may be distinct dependent on the specific portion 152, 154 being built from build material 108. For example, actuator device 138 may move build platform 134 away from window 112 at a first predetermined speed when building or forming first portion 152 of component 142, and may move build platform 134 away from window 112 at a second, distinct predetermined speed when building or forming second portion 154 of component 142. First predetermined speed may be slower than the second predetermined based on, at least in part, the difference in geometries, shapes, configurations, and/or sizes of each of the respective portions 152, 154 forming component 142. That is, where the component includes a portion that is smaller and/or requires less exposure/photochemical alternation to form that portion, build platform 134 may move at a fast speed than the remainder of built component 142.

FIG. 9 shows a cross-sectional view of AM system 100 including additional components and/or features. In the non-limiting example, AM system 100 may also include at least one propulsion device 156. Propulsion device(s) 156 may be positioned within cavity 110 of tank 106. Additionally, propulsion device(s) 156 may be positioned adjacent build platform 134 of AM apparatus 102. Propulsion device(s) 156 positioned within tank 106 may flow or aid in the flow of build material 108 to the space between window 112 of tank 106 and build surface 136 of build platform 134/exposed surface 144 of component 142 when building component 142, as discussed herein. Propulsion device(s) 156 may be formed as any suitable device, apparatus, and/or component that may move or flow build material 108 within tank 106 during the building process. For example, propulsion device(s) 156 may be formed as a submerged, motorized propeller. Two propulsion devices 156 are shown in FIG. 9. However, it is understood that this number of propulsion devices 156 is illustrative. As such, AM system 100 may include more or less propulsion devices therein.

Although shown and discussed herein as only forming component 142 with a single material (e.g., build material 108), it is understood that component 142 may be formed from a plurality of distinct materials. That is, unitary body of component 142 may include integral portions that are formed from distinct materials. In this example, the process discussed herein may be performed repeatedly using different build materials to form each distinct portion and/or may be paused during predetermined periods of the build to change the build material contained within tank 106.

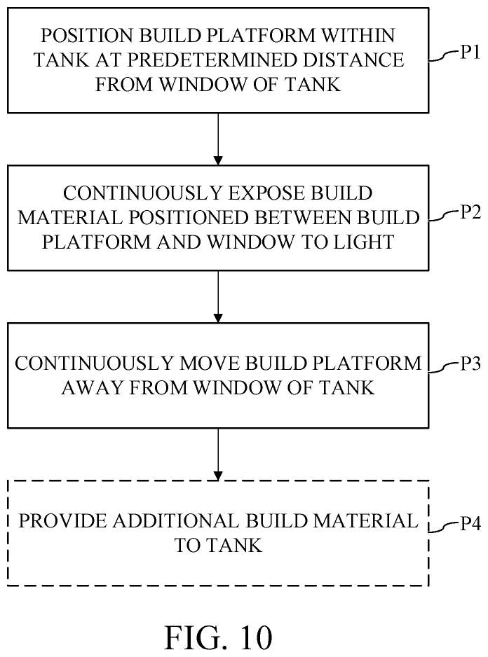

FIG. 10 depicts non-limiting example processes for building a component. Specifically, FIG. 10 shows a flowchart depicting example processes for building a component from a build material. In some cases, a computing device(s) and/or AM system may be used to perform the processes for building the component, as discussed herein with respect to FIGS. 1-9.

In process P1 a build platform of an additive manufacturing (AM) apparatus or system may be positioned within a tank of the AM apparatus. More specifically, the build platform of AM apparatus may be moved, repositioned, and/or adjusted to be positioned at a predetermined distance from a window of the tank. Additionally, the positioning of the build platform may also include submerging the build platform, and more specifically a build surface of the build platform, in a build material contained within the tank of the AM apparatus.

In process P2 the build material may be continuously exposed to a light. That is, at least a portion of the build material positioned between the build platform and the window of the tank may be exposed to a light generated by a light source/system. The generated light may pass through the window of the tank. Exposure to the light passing through the window may photochemically alter a composition of the build material. In a non-limiting example where the build material is formed from a liquid, prepolymer hydrogel, exposure to the light may result in the solidification of the portions of the hydrogel directly exposed. The continuous exposure to the light may also include dynamically altering a pattern of the light using a variable photomask component. The pattern of the light may define a geometry, shape, size, and/or configuration of the component being built from the build material. As such, when the pattern is dynamically altered during the continuous exposure, the shape, geometry, and/or configuration of the component being built using the AM apparatus may also be (dynamically) altered and/or formed.

In process P3 the build platform may move away from the window of the tank. More specifically, and simultaneous to or immediately subsequent to (e.g., less than three second) the continuous exposure to light (e.g., process P2), the build platform of the AM apparatus may continuously move away from the window of tank. In one example, continuously moving the build platform away from the window may include uninterruptedly repositioning the build platform away from the window at a single, predetermined speed. In another non-limiting example, continuously moving the build platform away from the window may include uninterruptedly repositioning the build platform away from the window at a plurality of predetermined speeds, where each of the plurality of predetermined speeds may be distinct form one another. In this non-limiting example, each of the plurality of predetermined speeds may be dependent upon a geometry, shape, size, and/or configuration of a section of the component built from the build material. Continuously moving the build platform away from the window may also include and/or result in flowing the building material between the window of the tank and the build platform and/or an exposed surface of the component being built. That is, liquid build material may (continuously) move or flow to a space between the build surface/partially built component and the window as the build platform continuously moves away from the window and the build material is continuously exposed to light. Furthermore, the continuous movement of the build platform may also generate a suction force in the tank. More specifically, continuously moving the build platform may generate a suction force within the tank between the continuously moving build platform and the build material contained in the tank. The suction force may pull the build material toward the space of the tank between the window and the build platform/exposed surface of the partially built component.

In process P4 (shown in phantom as optional), additional build material may be provided to the tank. More specifically, and as the build process proceeds with continuous exposure to light (e.g., process P2), additional build material may be provided, supplied, and/or transferred to the tank of the AM apparatus. The additional build material may be provided to the tank to ensure that the component may be built in a single, continuous build process. In a non-limiting example, the additional build material may be added from a build material reservoir while the component is still being built/only partially built.

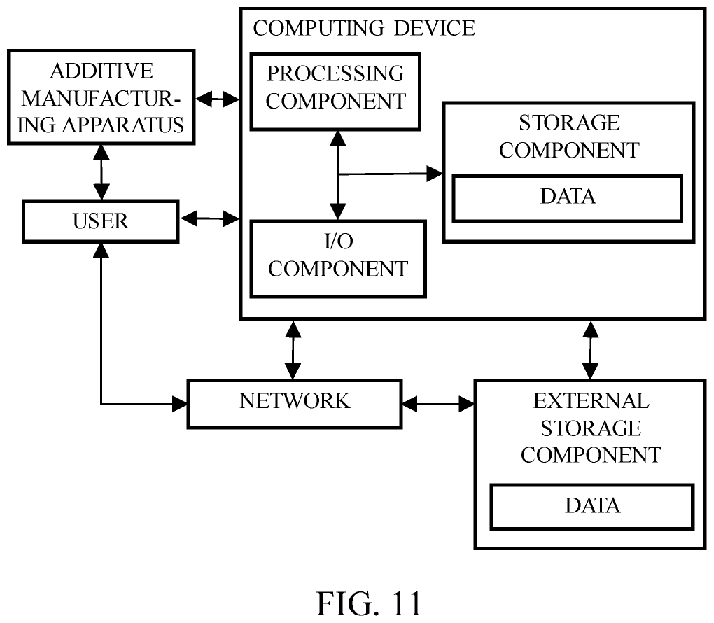

FIG. 11 depicts a schematic view of a computing environment or system (hereafter, “computing system”), and the various components included within computing system. In the non-limiting example shown in FIG. 11, computing system may include at least one computing device that may be configured to build a component from a build material by performing the processes P1-P4 discussed herein with respect to FIG. 10. It is understood that similarly named components may function in a substantially similar fashion. Redundant explanation of these components has been omitted for clarity.

It is to be understood that computing device(s) may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, single-board microcontroller, programmable logic circuitry, field-programmable gate arrays (FPGA), advanced RISC machines (ARM), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and/or computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Computing system shown in FIG. 11 may include any type of computing device(s) and for example includes at least one processor or processing component(s), storage component, input/output (I/O) component(s) (including a keyboard, touchscreen, or monitor display), and a communications pathway. In general, processing component(s) execute program code which is at least partially fixed or stored in storage component. While executing program code, processing component(s) can process data, which can result in reading and/or writing transformed data from/to storage component and/or 1/O component(s) for further processing. The pathway provides a communications link between each of the components in computing device(s). I/O component can comprise one or more human I/O devices, which enables user to interact with computing device(s) to model and ultimately build components using the additive manufacturing apparatus, as discussed herein. Computing device(s) may also be implemented in a distributed manner such that different components reside in different physical locations.

Storage component may also include modules, data and/or electronic information relating to various other aspects of computing system. Specifically, operational modules, electronic information, and/or data relating to component data (e.g., CAD files). The operational modules, information, and/or data may include the required information and/or may allow computing system, and specifically computing device, to perform the processes discussed herein for building a component from a build material using the additive manufacturing apparatus.

Computing system, and specifically computing device of computing system, may also be in communication with external storage component. External storage component may be configured to store various modules, data and/or electronic information relating to various other aspects of computing system, similar to storage component of computing device(s). Additionally, external storage component may be configured to share (e.g., send and receive) data and/or electronic information with computing device(s) of computing system. In the non-limiting example shown in FIG. 11, external storage component may include any or all of the operational modules and/or data shown to be stored on storage component. Additionally, external storage component may also include a secondary database that user may interact with, provide information/data to, and/or may include information/data relating to poster. In a non-limiting example, external storage component may be a cloud-based storage component or system. In other non-limiting examples, external storage component may also include and/or be in communication with a neural network to aid in computation and/or data processing as discussed herein.

In a non-limiting example shown in FIG. 11, computing device(s) may be in communication with and/or may be configured to share (e.g., send and receive) data and/or electronic information over a network. Network may represent a closed network, such as a local area network (LAN) or may include the internet. Network may also include secondary database including similar data as storage component, and/or may include or be in communication with a neural network to aid in computation and/or data processing as discussed herein.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As discussed herein, various systems and components are described as “obtaining” data. It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. In one non-limiting example, and as discussed herein, it is understood that processes P2 and P3 may be performed concurrently when building a component for a build material (e.g., hydrogel). Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An additive manufacturing system, comprising:
a tank containing a build material, the tank including a window;
a light source positioned adjacent to the tank, the light source providing light through the window of the tank;
a build platform positioned within the tank and opposite the light source, the build platform adjacent to the window of the tank;
an actuator device coupled to the build platform, the actuator device selectively moving the build platform within the tank and relative to the window; and
at least one computing device operably coupled to the actuator device, the at least one computing device configured to control the operation of the actuator device to build a component from the build material on the build platform by:
initially positioning the build platform within the tank at predetermined distance from the window, the build platform at least partially submerged in any build material contained in the tank; and
moving the build platform relative to the window and the light source thereby building a component from the build material.

2. The additive manufacturing system of claim 1, wherein the build material includes hydrogel material.

3. The additive manufacturing system of claim 2, wherein the hydrogel material includes a predetermined viscosity.

4. The additive manufacturing system of claim 1, wherein the at least one computing device is configured to continuously move the build platform by uninterruptedly repositioning the build platform relative to the window at a predetermined speed.

5. The additive manufacturing system of claim 1, wherein the at least one computing device is configured to continuously move the build platform by uninterruptedly repositioning the build platform relative to the window at a plurality of predetermined speeds.

6. The additive manufacturing system of claim 5, wherein each of the plurality of predetermined speeds dependent upon a geometry of a section of the component on the build platform.

7. The additive manufacturing system of claim 1, further comprising at least one fluid inlet in fluid communication with the tank, the at least one fluid inlet selectively providing build material to the tank.

8. The additive manufacturing system of claim 1, further comprising at least one propulsion device position within the tank, the at least one propulsion device flowing the build material between the window of the tank and the build platform.

9. A method for building a component from a build material, comprising:
positioning a build platform within a tank at a predetermined distance from a window of the tank, the build platform at least partially submerged in a build material contained in the tank;
exposing at least a portion the build material positioned between the build platform and the window of the tank to a light to photochemically alter a composition of the build material; and
moving the build platform relative to the window of the tank during the exposure to the light, thereby building a component.

10. The method of claim 9, wherein moving the build platform relative to the window of the tank further includes uninterruptedly repositioning the build platform at a predetermined speed.

11. The method of claim 9, wherein moving the build platform relative to the window of the tank further includes uninterruptedly repositioning the build platform at a plurality of predetermined speeds.

12. The method of claim 11, wherein each of the plurality of predetermined speeds are dependent upon a geometry of a section of the component.

13. The method of claim 9, further comprising providing additional build material to the tank during the building of the component.

14. The method of claim 9, wherein moving the build platform relative to the window of the tank further includes flowing the build material between the window of the tank and the build platform.

15. The method of claim 9, wherein moving the build platform away from the window of the tank further includes generating a suction force within the tank between the build platform and the build material contained in the tank, the suction force pulling the build material toward a space of the tank between the window and the build platform.

16. The method of claim 9, wherein exposing at least the portion the build material positioned between the build platform and the window of the tank to the light further includes dynamically altering a pattern of the light using a variable photomask component, the pattern of the light defining a geometry of the component being built from the build material.

17. A computer program product comprising program code stored on a non-transitory computer readable storage medium, which when executed by at least one computing device, causes the at least one computing device to build a component from a build material using an additive manufacturing system by performing a process including the steps of:
positioning a build platform of the additive manufacturing system within a tank of the additive manufacturing system at predetermined distance from a window of the tank, the build platform at least partially submerged in the build material contained in the tank;
exposing at least a portion the build material positioned between the build platform and the window of the tank to a light generated by a light source of the additive manufacturing system to photochemically alter a composition of the build material; and
moving the build platform relative to the window of the tank during the exposure to the light.

18. The computer program product of claim 17, wherein moving the build platform relative to the window of the tank further includes uninterruptedly repositioning the build platform at a predetermined speed.

19. The computer program product of claim 17, wherein moving the build platform relative to the window of the tank further includes uninterruptedly repositioning the build platform at a plurality of predetermined speeds.

20. The computer program product of claim 19, wherein each of the plurality of predetermined speeds are dependent upon a geometry of a section of the component being built from the build material.
